(19) United States
(12) Patent Application Publication
(10) Pub. No.: US 2026/0364975 A1
(43) Pub. Date: Nov. 19, 2026

(54) POLYURETHANE FLEXURE-ELONGATED COMPOSITE SPOKE BONDED COMBINATION FOR NON-PNEUMATIC TIRE AND METHODS OF PRODUCING SAME

(71) Applicant: Bridgestone Americas Tire Operations, LLC, Nashville, TN (US)

(72) Inventors: Vishal K. Chaurasia, Kent, OH (US); Daniel Hunt, Cleveland, OH (US); Nicholas J. Harp, Massillon, OH (US)

(73) Assignee: Bridgestone Americas Tire Operations, LLC, Nashville, TN (US)

(21) Appl. No.: 19/514,957

(22) PCT Filed: Jul. 25, 2024
(86) PCT No.: PCT/US2024/039504

§ 371 Date: Feb. 27, 2026

Related U.S. Application Data
(60) Provisional application No. 63/581,422, filed on Sep. 8, 2023.

(51) Int. Cl. B60C 7/14

(52) U.S. Cl. CPC B60C 7/146

(57) ABSTRACT

A method for producing a polyurethane flexure-elongated composite spoke bonded combination for use in a non-pneumatic tire, the polyurethane flexure-elongated composite spoke bonded combination produced by the method, and a polyurethane flexure-elongated composite spoke bonded combination for use in a non-pneumatic tire. The method includes application of a peel ply fabric to at least the first surface (at an end) of an uncured elongated composite spoke, application of a solvent-based isocyanate-containing activator, and ultimately insert molding a polyurethane flexure onto the cured elongated composite spoke. Also disclosed are non-pneumatic tires incorporating a polyurethane flexure-elongated composite spoke bonded combination made by the disclosed methods, resulting from the disclosed methods, or as otherwise disclosed herein. The polyurethane flexure-elongated composite spoke bonded combination has a specified peel strength.

### FIELD

The present application is directed to a polyurethane flexure-elongated composite spoke bonded combination for use in non-pneumatic tires and to related methods of producing the polyurethane flexure-elongated composite spoke bonded combination and non-pneumatic tires containing the bonded combination.

### BACKGROUND

Conventional (pneumatic) tires are inflated with air. Non-pneumatic tires can be considered airless because they do not rely upon air inflation to support vehicle weight or to absorb shock from a road surface. A non-pneumatic tire offers advantages including lower maintenance and lack of puncture risk. Various designs have been proposed for non-pneumatic tires including those which make use of a network of spokes connected to an inner rim-like structure and covered by an outer band or ring and a relatively thin layer of rubber as tread. In such a design, the spokes function to provide support for the vehicle weight.

### SUMMARY

Disclosed herein is a polyurethane flexure-elongated composite spoke bonded combination for use in non-pneumatic tires, methods of producing the same, and non-pneumatic tires incorporating the polyurethane flexure-elongated composite spoke bonded combination.

In a first embodiment, a method for producing a polyurethane flexure-elongated composite spoke bonded combination for use in non-pneumatic tires is disclosed. This method of the first embodiment comprises providing an uncured elongated composite spoke having an end with a first surface and a second surface, wherein the uncured elongated composite spoke is comprised of fibers selected from the group consisting of carbon fibers, glass fibers, aramid fibers, and combinations thereof and an epoxy resin; applying a peel ply fabric to at least the first surface of the uncured elongated composite spoke to produce a peel ply fabric-uncured elongated composite spoke combination, wherein the peel ply fabric comprises woven synthetic fabric having warp threads and weft threads; curing the peel ply fabric-uncured elongated composite spoke combination by the application of heat and pressure to produce a cured peel ply fabric-cured elongated composite spoke combination; removing the cured peel ply fabric from the cured peel ply fabric-cured elongated composite spoke combination to produce a cured elongated composite spoke having a texture imprint surface; applying a solvent-based isocyanate-containing activator over the texture imprint surface to produce a treated texture imprint surface; and insert molding a polyurethane flexure onto at least a portion of the treated texture imprint surface, thereby producing a polyurethane flexure-elongated composite spoke bonded combination having a peel strength of at least 120 pli (at least 21000 N/m), preferably at least 140 pli (at least 24000 N/m), more preferably at least 150 pli at 26000 N/m, as determined using a 90 degree peel strength test (in accordance with ASTM D6892/D903).

In a second embodiment, a polyurethane-flexure elongated composite spoke bonded combination produced by the method of the first embodiment is disclosed.

In a third embodiment, a non-pneumatic tire incorporating the polyurethane-flexure elongated composite spoke bonded combination of the second embodiment is disclosed.

In a fourth embodiment, a polyurethane flexure-elongated composite spoke bonded combination for use in non-pneumatic tires is disclosed. This polyurethane flexure-elongated composite spoke bonded combination comprises a cured elongated composite spoke having an end with a first surface and a second surface, wherein the cured elongated composite spoke is comprised of fibers selected from the group consisting of carbon fibers, glass fibers, aramid fibers, and combinations thereof and an epoxy resin; and a polyurethane flexure bonded to the end of the cured elongated composite spoke with a peel strength of at least 120 pli (at least 21000 N/m), preferably at least 140 pli (at least 24000 N/m), more preferably at least 150 pli at 26000 N/m, as determined using a 90 degree peel strength test (in accordance with ASTM D6892/D903), wherein the end of the cured elongated composite spoke has a treated texture imprint surface upon at least its first surface underneath the bonded polyurethane flexure, wherein the treated texture imprint surface includes a treatment coating over a texture imprint surface.

In a fifth embodiment, a non-pneumatic tire incorporating the polyurethane-flexure elongated composite spoke bonded combination of the fourth embodiment is disclosed.

### DETAILED DESCRIPTION

In a first embodiment, a method for producing a polyurethane flexure-elongated composite spoke bonded combination for use in non-pneumatic tires is disclosed. This method of the first embodiment comprises providing an uncured elongated composite spoke having an end with a first surface and a second surface, wherein the uncured elongated composite spoke is comprised of fibers selected from the group consisting of carbon fibers, glass fibers, aramid fibers, and combinations thereof and an epoxy resin; applying a peel ply fabric to at least the first surface of the uncured elongated composite spoke to produce a peel ply fabric-uncured elongated composite spoke combination, wherein the peel ply fabric comprises woven synthetic fabric having warp threads and weft threads; curing the peel ply fabric-uncured elongated composite spoke combination by the application of heat and pressure to produce a cured peel ply fabric-cured elongated composite spoke combination; removing the cured peel ply fabric from the cured peel ply fabric-cured elongated composite spoke combination to produce a cured elongated composite spoke having a texture imprint surface; applying a solvent-based isocyanate-containing activator over the texture imprint surface to produce a treated texture imprint surface; and insert molding a polyurethane flexure onto at least a portion of the treated texture imprint surface, thereby producing a polyurethane flexure-elongated composite spoke bonded combination having a peel strength of at least 120 pli (at least 21000 N/m), preferably at least 140 pli (at least 24000 N/m), more preferably at least 150 pli at 26000 N/m, as determined using a 90 degree peel strength test (in accordance with ASTM D6892/D903).

In a second embodiment, a polyurethane-flexure elongated composite spoke bonded combination produced by the method of the first embodiment is disclosed.

In a third embodiment, a non-pneumatic tire incorporating the polyurethane-flexure elongated composite spoke bonded combination of the second embodiment is disclosed.

In a fourth embodiment, a polyurethane flexure-elongated composite spoke bonded combination for use in non-pneumatic tires is disclosed. This polyurethane flexure-elongated composite spoke bonded combination comprises a cured elongated composite spoke having an end with a first surface and a second surface, wherein the cured elongated composite spoke is comprised of fibers selected from the group consisting of carbon fibers, glass fibers, aramid fibers, and combinations thereof and an epoxy resin; and a polyurethane flexure bonded to the end of the cured elongated composite spoke with a peel strength of at least 120 pli (at least 21000 N/m), preferably at least 140 pli (at least 24000 N/m), more preferably at least 150 pli at 26000 N/m, as determined using a 90 degree peel strength test (in accordance with ASTM D6892/D903), wherein the end of the cured elongated composite spoke has a treated texture imprint surface upon at least its first surface underneath the bonded polyurethane flexure, wherein the treated texture imprint surface includes a treatment coating over a texture imprint surface.

In a fifth embodiment, a non-pneumatic tire incorporating the polyurethane-flexure elongated composite spoke bonded combination of the fourth embodiment is disclosed.

### Uncured Elongated Composite Spoke

According to the first embodiment, an uncured elongated composite spoke is provided which will become part of the polyurethane flexure-elongated composite spoke bonded combination. In the second-fifth embodiments, the elongated composite spoke exists in cured form as part of the polyurethane flexure-elongated composite spoke bonded combination. Generally, according to the first-fifth embodiments, the spoke is comprised of a composite material and has an elongated shape. It should be understood that the elongated composite spoke is uncured prior to application of a peel ply fabric (since, as discussed in detail below, the spoke and peel ply fabric are cured together). In certain embodiments of the first-fifth embodiments, the elongated shape of the spoke can be understood as being a rod or rod-like. According to the first-fifth embodiments, the elongated composite spoke can be understood as having a first end and a second end, with the first end being the end which will attach to the outer ring of a non-pneumatic tire (via the polyurethane flexure) and the second end being the end which will attach (either directly or indirectly) to an inner rim-like structure of a non-pneumatic tire. According to the first-fifth embodiments, the elongated composite spoke has an end (the first end) with a first surface and a second surface. As discussed in more detail below, peel ply fabric is applied to at least the first surface of the spoke (i.e., at least the first surface of the first end of the spoke).

The spoke is elongated in that it extends radially between the first end and the second end. In certain embodiments of the first-fifth embodiments, the elongated composite spoke has a substantially rectangular cross section that includes a first surface and a second surface facing opposite the first surface. In other alternative embodiments of the first-fifth embodiments, the spoke may have any desired cross section shape (e.g., circle, ellipse, diamond, hexagon, etc.) or may have a combination of different cross section shapes; in certain embodiments of the foregoing when the cross section shape is circular or elliptical, the first end of the spoke has a first flattened surface and optionally a second flattened surface. In certain embodiments of the first-fifth embodiments, the spoke has a constant thickness between the first end and the second end. In alternative embodiments of the first-fifth embodiments, the thickness of a spoke may vary between the first and second ends; for example, the spoke may have relatively thicker portions at the first and second ends and a relatively thinner portion between the ends.

According to the first-fifth embodiments, the composite spoke is comprised of fibers selected from the group consisting of carbon fibers, glass fibers, aramid fibers, and combinations thereof and an epoxy resin. Thus, the term composite can be understood as referring to a combination of one or more of such fibers with an epoxy resin. In certain embodiments of the first-fifth embodiments, the composite spoke is comprised of carbon fibers and an epoxy resin. In other embodiments of the first-fifth embodiments, the composite spoke is comprised of glass fibers and an epoxy resin.. In yet other embodiments of the first-fifth embodiments, the composite spoke is comprised of aramid fibers and an epoxy resin.

As mentioned above, the elongated composite spoke of the first-fifth embodiments is comprised of materials which include an epoxy resin. The properties of the epoxy resin may vary. In preferred embodiments of the first-fifth embodiments, the epoxy resin of the uncured elongated composite spoke has a cure time of no more than 15 minutes (e.g., 15, 14, 13, 12, 11, 10, 9, 8, 7, 6, 5 minutes or less) at 150 °C, 5-15 minutes at 150 °C, preferably no more than 12 minutes (e.g., 12, 11, 10, 9, 8, 7, 6, 5 minutes or less) at 150 °C, or 5-12 minutes at 150 °C. In other embodiments of the first-fifth embodiments, the epoxy resin of the uncured elongated composite spoke has a cure time of more than 15 minutes (e.g., 16 minutes, 30 minutes, 45 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, or more) at 150 °C, 16 minutes to 24 hours at 150 °C, or 16 minutes to 6 hours (e.g., 16 minutes, 30 minutes, 45 minutes, 1 hour, 2 hours, 3 hours, 4 hours, 5 hours, or 6 hours) at 150 °C. The epoxy resin of the uncured elongated composite spoke is referred to since the resin in the uncured spoke has a measurable cure time. It should be understood that the same epoxy resin in cured form will be present in the cured elongated composite spoke as well as in the elongated spoke present in the polyurethane flexure-elongated composite spoke bonded combination and the non-pneumatic tire incorporating the combination.

### Peel Ply Fabric and Applying

The method of the first embodiment includes applying a peel ply fabric to at least the first surface of the uncured composite spoke to produce a peel ply fabric-uncured composite spoke combination. In certain embodiments of the first embodiment, the method includes applying the peel ply fabric to (only) the first surface of the uncured composite spoke to produce a peel ply fabric-uncured composite spoke combination. In other embodiments of the first embodiment, the method incudes applying the peel ply fabric to both the first surface and the second surface of the uncured composite spoke to produce a peel ply fabric-uncured composite spoke combination; in certain such embodiments, applying the peel ply fabric includes wrapping the peel ply fabric around the entire outer surface of the first end of the elongated spoke (i.e., both the first surface and the second surface as well as any other surfaces between those two surfaces). According to the method of the first embodiment, the peel ply fabric comprises woven synthetic fabric having both warp threads and weft threads. As should be apparent from the discussion below (e.g., removing the cured peel ply), the polyurethane flexure-elongated composite spoke bonded combination of the second and fourth embodiments includes a texture imprint surface (resulting from the peel ply fabric, which is removed) upon at least its first surface (at the first end) which will be underneath the bonded polyurethane flexure and facilitate secure bonding of the polyurethane flexure. The non-pneumatic tire of the third and fifth embodiments has incorporated the polyurethane flexure-elongated composite spoke bonded combination of the second and fourth embodiments, respectively, and, thus, will include the same texture imprint as the second and fourth embodiments, respectively.

According to the first embodiment, the composition of the peel ply fabric may vary. As mentioned above, the peel ply fabric comprises woven synthetic fabric having warp threads and weft threads. Weft threads may also be referred to as pick threads or fill threads. Generally, weft threads can be understood as threads which intersect with warp threads. According to the first embodiment, the angle of intersection can vary from being about 90 degrees, 90 degrees, about 80 degrees, 80 degrees, or 20 to 90 degrees (e.g., 20, 25, 30, 35, 40, 45, 50, 55, 60, 65, 70, 75, 80, 85, or 90 degrees), with angles less than 90 degrees referring to the acute angle of intersection rather than the obtuse angle of intersection. In certain preferred embodiments of the first embodiment, the warp threads are parallel or substantially parallel to each other and the weft threads are parallel or substantially parallel to each other. According to the first embodiment, the particular materials used for the warp threads and the weft threads may vary. In certain embodiments of the first embodiment, the warp threads and weft threads of the woven synthetic fabric are comprised of a material selected from the group consisting of nylon, polyester, fiberglass, aramid, and combinations thereof. In certain embodiments of the first embodiment, the warp threads and weft threads are comprised of the same type of material (e.g., both are nylon). In other embodiments of the first embodiment, the warp threads and weft threads are comprised of different materials (e.g., one is nylon and the other is polyester). In certain embodiments of the first embodiment, the warp threads and weft threads are comprised of nylon; in certain such embodiments, the warp and weft threads consist of nylon. In certain embodiments of the first embodiment, the warp threads and weft threads are comprised of polyester; in certain such embodiments, the warp and weft threads consist of polyester. In certain embodiments of the first embodiment, the warp threads and weft threads are comprised of fiberglass; in certain such embodiments, the warp and weft threads consist of fiberglass. In certain embodiments of the first embodiment, the warp threads and weft threads are comprised of aramid; in certain such embodiments, the warp and weft threads consist of aramid.

According to the first embodiment, the woven synthetic fabric of the peel ply fabric may have varying woven density in terms of the number of warp threads/cm and the number of weft threads/cm. In certain embodiments of the first embodiment, the woven synthetic fabric of the peel ply fabric has 10 to 100 warp threads/cm (e.g., 10, 15, 20, 25, 30, 35, 40, 45, 50, 55, 60, 65, 70, 75, 80, 85, 90, 95 or 100 warp threads/cm), preferably 15 to 80 warp threads/cm (e.g., 15, 20, 25, 30, 35, 40, 45, 50, 55, 60, 65, 70, 75, or 80 warp threads/cm). In certain embodiments of the first embodiment, the woven synthetic fabric of the peel ply fabric has 10 to 60 weft threads/cm (e.g., 10, 15, 20, 25, 30, 35, 40, 45, 50, 55, or 60 weft threads/cm), preferably 15 to 40 weft threads/cm (e.g., 15, 20, 25, 30, 35, or 40 weft threads/cm). In certain embodiments of the first embodiment, the woven synthetic fabric of the peel ply fabric has 10 to 100 warp threads/cm (e.g., 10, 15, 20, 25, 30, 35, 40, 45, 50, 55, 60, 65, 70, 75, 80, 85, 90, 95 or 100 warp threads/cm), preferably 15 to 80 warp threads/cm (e.g., 15, 20, 25, 30, 35, 40, 45, 50, 55, 60, 65, 70, 75, or 80 warp threads/cm) and 10 to 60 weft threads/cm (e.g., 10, 15, 20, 25, 30, 35, 40, 45, 50, 55, or 60 weft threads/cm), preferably 15 to 40 weft threads/cm (e.g., 15, 20, 25, 30, 35, or 40 weft threads/cm).

In certain embodiments of the first embodiment, the peel ply fabric is free of resin. In certain embodiments of the foregoing, the peel ply fabric is free of resin but includes at least one release agent and in other embodiments of the foregoing, the peel ply fabric is free of resin and is free of release agents. In other embodiments of the first embodiment, the peel ply fabric includes a resin (in addition to the woven synthetic fabric). In certain embodiments of the foregoing, the peel ply fabric includes a resin and at least one release agent and in other embodiments of the foregoing, the peel ply fabric includes a resin and is free of release agents. According to such embodiments, the resin that is used may vary, although preferably the resin has a cure time of no more than 15 minutes (e.g., 15, 14, 13, 12, 11, 10, 9, 8, 7, 6, 5 minutes or less) at 150 °C, more preferably a cure time of no more than 12 minutes (e.g., 12, 11, 10, 9, 8, 7, 6, 5 minutes or less) at 150 °C. In preferred embodiments of the first embodiment where the peel ply fabric includes a resin, the resin is an epoxy resin, preferably having a cure time of no more than 15 minutes (e.g., 15, 14, 13, 12, 11, 10, 9, 8, 7, 6, 5 minutes or less) at 150 °C, more preferably a cure time of no more than 12 minutes (e.g., 12, 11, 10, 9, 8, 7, 6, 5 minutes or less) at 150 °C.

In certain embodiments of the first embodiment, the peel ply fabric is free of release agents. Release agents are ingredients that are added to the peel ply fabric to facilitate easier removal of the fabric portion from the surface of the cured composite spoke. In other embodiments of the first embodiment, the peel ply fabric contains at least one release agent. In those embodiments of the first embodiment where the peel ply fabric contains at least one release agent, various release agents as currently used with peel ply fabric may be suitable. Exemplary such release agents include silicon-based release agents and fluorine-based release agents (e.g., polytetrafluoroethylene). In those embodiments of the first embodiment wherein the peel ply fabric contains at least one release agent, care should be taken minimize the transfer of release agent onto the surface of the composite spoke, e.g., by selection of a peel ply fabric with an appropriate release agent.

### Curing

The method of the first embodiment includes curing the peel ply fabric-uncured elongated composite spoke combination to produce a cured peel ply fabric-cured elongated composite spoke combination. Such curing can be understood as including the application of heat and pressure to produce the cured peel ply fabric-cured elongated composite spoke combination. The pressure used as part of the curing process may vary and can be used to assist in adhesion of the peel ply fabric to the surface of the spoke. In certain embodiments of the first embodiment, curing includes applying a pressure of 1 to 300 psig (e.g., 1, 10, 20, 30, 40, 50, 60, 70, 80, 90, 100, 110, 120, 130, 140, 150, 160, 170, 180, 190, 200, 210, 220, 230, 240, 250, 260, 270, 280, 290 or 300 psig) or 7 to 2100 kPa (e.g., 7, 50, 100, 200, 300, 400, 500, 600, 700, 800, 900, 1000, 1100, 1200, 1300, 1400, 1500, 1600, 1700, 1800, 1900, 2000, or 2100 kPa), preferably 5 to 100 psig (e.g., 5, 10, 15, 20, 25, 30, 35, 40, 45, 50, 55, 60, 65, 70, 75, 80, 85, 90, 95, or 100 psig) or 35 to 700 kPa (e.g., 35, 50, 100, 200, 300, 400, 500, 600, or 700 kPa). As used herein psig refers to pounds per square inch in gauge and kPa refers to kiloPascals. The heat used as part of the curing process may vary. In certain embodiments of the first embodiment, curing includes heating the combination at a temperature of 75 to 400 °F (e.g., 75, 80, 85, 90, 95, 100, 110, 120, 125, 130, 140, 150, 160, 170, 175, 180, 190, 200, 210, 220, 225, 230, 240, 250, 260, 270, 275, 280, 290, 300, 310, 320, 325, 330, 340, 350, 360, 370, 375, 380, 390, or 400 °F) or 24 to 200 °C (e.g., 24, 25, 30, 40, 50, 60, 70, 75, 80, 90, 100, 110, 120, 125, 130, 140, 150, 160, 170, 175, 180, 190, or 200 °C). In other embodiments of the first embodiment, curing includes heating the combination at a temperature of 250 to 350 °F (e.g., 250, 260, 270, 275, 280, 290, 300, 310, 320, 325, 330, 340, or 350 °F) or 120 to 175 °C (e.g., 120, 130, 140, 150, 160, 170, or 175 °C). In certain embodiments of the first embodiment, the curing includes the application of heat at one of the foregoing temperatures and pressure at one of the forgoing values. As should be apparent from the discussion below (e.g., removing the cured peel ply fabric), the fabric portion of the peel ply (i.e., the woven synthetic fabric having warp threads and weft threads) is removed from the cured peel ply fabric-cured elongated composite spoke combination leaving behind a texture imprint on the surface of the first end of the cured elongated composite spoke where the peel ply fabric was applied and then removed (i.e., at least the first surface).

### Removing the Peel Ply Fabric

The method of the first embodiment includes removing the cured peel ply fabric from the cured peel ply fabric-cured elongated composite spoke combination to produce a cured elongated composite spoke having a texture imprint surface upon at least its first surface. As mentioned above, the texture imprint surface is left behind when the fabric portion of the peel ply (i.e., the woven synthetic fabric having warp threads and weft threads) is removed from the cured peel ply fabric-cured elongated composite spoke combination. This texture imprint surface will be present on the surface of the first end of the cured elongated composite spoke where the peel ply fabric was applied and then removed (i.e., at least the first surface). Accordingly, in certain embodiments of the first embodiment, the texture imprint surface is present upon the first surface at the (first) end of the cured elongated spoke. In other embodiments of the first embodiment, the texture imprint surface is present upon both the first surface and the second surface of the cured composite spoke; in certain such embodiments, the texture imprint surface is present upon the entire outer surface of the first end of the elongated spoke (i.e., both the first surface and the second surface as well as any other surfaces between those two surfaces). It should be understood that the foregoing discussion relating to the texture imprint surface applies equally to the second-fifth embodiments disclosed herein.

When the peel ply fabric is removed from the cured peel ply fabric-cured elongated composite spoke combination, care should be taken to avoid damaging the underlying spoke. Generally, the removal process should avoid fracturing or exposing the fibers present in the underlying spoke. Initial lifting of a corner of the peel ply fabric can be useful in successfully removing the cured peel ply fabric without damaging the underlying spoke. Any instrument or tool used to assist in lifting a corner of the peel ply fabric should be chosen so as to avoid damage to the underlying spoke.

According to the first-fifth embodiments, the configuration and roughness of the texture imprint surface may vary depending upon the type of peel ply fabric utilized. The roughness of the texture imprint surface can be determined by profilometry (i.e., using a Profilometer) using standard methods such as ISO 4287. Exemplary values obtained by profilometry include the roughness average (Ra) which can be understood as the arithmetic average of the absolute values of profile heights over the evaluation length and average maximum height of the profile or average maximum profile height (Rz) which can be understood as the average of successive values of Rti calculated over the evaluation length; Rz is the same as Rz(DIN) when there are five sampling lengths within the evaluation length. The evaluation length is the length over which the values of surface parameters are evaluated and may also be referred to as assessment length. Rti refers to the maximum heights within a sampling length and can be understood as the vertical distance between the highest and lowest points of the profile within a sampling length. Sampling length is the nominal wavelength used for separating roughness and waviness. Evaluation length refers to the overall length over which the values of surface parameters are evaluated. Measurements of Ra and Rz referred to herein were measured using a Surtronic® Duo portable surface roughness tester configured as follows: diamond type stylus with a radius of 5 micrometers (200 microinches), gauge force of 200 mg, gauge measurement type skidded, Gaussian filter type, 0.8 mm filter cut-off, evaluation or traverse length of 4 mm (0.157 inches), evaluation or traverse speed of 2 mm/seconds (0.08 inches/second), and a continuous measurement mode over the traverse length.

In certain embodiments of the first-fifth embodiments, the texture imprint surface has a roughness average Ra of 150 to 450 microinches (e.g., 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, or 450 microinches) or 4 to 11 micrometers (e.g., 4, 5, 6, 7, 8, 9, 10, or 11 micrometers), preferably 200 to 400 microinches (e.g., 200, 210, 220, 230, 240, 250, 260, 270, 280, 290, 300, 310, 320, 330, 340, 350, 360, 370, 380, 390, or 400 microinches) or 5 to 10 micrometers (e.g., 5, 6, 7, 8, 9, or 10 micrometers), as determined by profilometry, as discussed above. In certain embodiments of the first-fifth embodiments, the texture imprint surface has an average maximum height of the profile or average maximum profile height Rz of 1200 to 1700 microinches (e.g., 1200, 1300, 1400, 1500, 1600, or 1700 microinches) or 30 to 43 micrometers (e.g., 30, 31, 32, 33, 34, 35, 36, 37, 38, 39, 40, 41, 42, or 43 micrometers), preferably 1300 to 1600 microinches (e.g., 1300, 1400, 1500, 1600, or 1700 microinches) or 33 to 41 micrometers (e.g., 33, 34, 35, 36, 37, 38, 39, 40, or 41 micrometers), as determined by profilometry, as discussed above. In certain embodiments of the first-fifth embodiments, the texture imprint has a surface roughness average Ra and an average maximum height of the profile Rz according to the foregoing respective ranges, preferably according to the foregoing respective preferred ranges.

### Applying Solvent-Based Isocyanate-Containing Activator and Resulting Treatment Coating

The method of the first embodiment includes applying a solvent-based isocyanate-containing activator over the texture imprint surface (of the cured elongated composite spoke) to produce a treated texture imprint surface (which is upon at least the first surface of the cured elongated composite spoke). As mentioned above, the treated texture imprint surface of the fourth and fifth embodiments, includes (comprises) a treatment coating (resulting from the solvent-based isocyanate containing activator) over a texture imprint surface. As should be apparent from the discussion infra, the treated texture imprint surface is present in second-fifth embodiments disclosed herein. With respect to the second-fifth embodiments disclosed herein, the end of the elongated spoke has a treated texture imprint surface upon at least its first surface (underneath the bonded polyurethane flexure). As discussed above, the texture imprint surface upon the cured elongated composite spoke results from application and removal of a cured peel ply fabric to at least the first surface of the cured elongated composite spoke. Generally, according to the method of the first embodiment, the solvent-based isocyanate-containing activator will be applied to any surface of the cured elongated composite spoke which has a texture imprint surface from the peel ply fabric. As discussed above, the peel ply fabric is applied to (and removed from) at least the first surface of the uncured elongated composite spoke, which can include only the first surface of the uncured elongated composite spoke, both the first surface and the second surface of the uncured elongated composite spoke, and the entire outer surface of the first end of the elongated spoke (i.e., both the first surface and the second surface as well as any other surfaces between those two surfaces). The treatment coating (or treated texture imprint surface) that results from applying the solvent-based isocyanate-containing activator over the texture imprint surface (of at least the first surface of the cured elongated composite spoke) and leads to the treatment coating may vary in thickness. In certain embodiments of the first-fifth embodiments, the treatment coating has a thickness of 0.5 to 10 nm (e.g., 0.5, 1, 1.5, 2, 2.5, 3, 3.5, 4, 4.5, 5, 5.5, 6, 6.5, 7, 7.5, 8, 8.5, 9, 9.5 or 10 nm). Nm being understood as nanometers. In other embodiments of the first-fifth embodiments, the treatment coating has a thickness of less than 0.5 nm. The thickness of the treatment coating refers to thickness after evaporation of the solvents from the applied solvent-based isocyanate-containing activator. The presence of the treatment coating (resulting from the use of the solvent-based isocyanate-containing activator) can be confirmed by use of FT-IR ATR (Fourier Transform Infrared spectroscopy with Attenuated Total Reflection) to detect an isocyanate peak or by use of a contact angle goniometer (which measures the contact angle of a droplet on a surface). The foregoing discussion relating to the properties of the treatment coating and treated texture imprint surface should be understood to apply equally to the second-fifth embodiments disclosed herein.

According to the first embodiment, methods of applying the solvent-based isocyanate-containing activator over the texture imprint surface (of the cured elongated composite spoke) to produce a treated texture imprint surface may vary. In certain embodiments of the first embodiment, the solvent-based isocyanate-containing activator is applied by spray coating, roll coating, dipping, or wiping. In preferred embodiments of the first embodiment, the solvent-based isocyanate-containing activator is applied by wiping. In other embodiments of the first embodiment, the solvent-based isocyanate-containing activator is applied by roll coating. Generally, roll coating comprises use of at least one roller (e.g., one roller, two rollers, three rollers, or more) to transfer a layer of material (i.e., the solvent-based isocyanate-containing activator) to the surface of a part (i.e., the texture imprint surface of the cured elongated composite spoke). In certain embodiments of the first embodiment wherein roll coating is used for applying the solvent-based isocyanate-containing activator, the roll coating includes a controller for controlling or adjusting the thickness of the activator that is applied to the texture imprint surface. Exemplary such controllers include a metering blade, a metering roller, and transfer from another roll. In other embodiments of the first embodiment, the solvent-based isocyanate activator is applied by spray coating. In yet other embodiments of the first embodiment, the solvent-based isocyanate-containing activator is applied by dipping (e.g., by dipping at least the texture imprint surface of the cured elongated composite spoke into a container containing the solvent-based isocyanate-containing activator).

As should be apparent from the above discussion, the solvent-based isocyanate-containing activator includes both isocyanate(s) (an isocyanate component) and solvent (a solvent component). In certain embodiments of the first embodiment, the solvent-based isocyanate-containing activator may contain (include) one or more additional ingredients, i.e., in addition to the isocyanate and solvent. Exemplary such additional ingredients include coupling agents, pigments and tracers. For the avoidance of doubt, each of these additional ingredients can include one or more than one ingredient (e.g., while coupling agents is specified, one or more than one coupling agent may be present). The presence of a pigment in the solvent-based isocyanate-containing activator may be useful for identifying where the activator has been placed upon the texture imprint surface. Similarly, the presence of a tracer or tracers (e.g., a UV tracer) in the solvent-based isocyanate-containing activator may be useful for identifying where the activator has been placed upon the texture imprint surface when UV detection methods are available to be utilized. The foregoing discussion relating to the isocyanate(s) and solvent(s) present in the solvent-based isocyanate-containing activator should be understood to apply equally to the second and third embodiments disclosed herein. The foregoing discussion relating to the isocyanate(s) present in the solvent-based isocyanate-containing activator should be understood to apply equally to the second-fifth embodiments disclosed herein (since according to the second-fifth embodiments, the isocyanate(s) will remain in the treatment coating even after the solvent(s) have been evaporated).

According to the first embodiment, the isocyanate and solvent present in the solvent-based isocyanate-containing activator may vary. In certain embodiments of the first embodiment, the solvent-based isocyanate-containing activator includes (comprises) a polyisocyanate (as the isocyanate/isocyanate component). In those embodiments of the first embodiment wherein the solvent-based isocyanate-containing activator includes a polyisocyanate, the particular polyisocyanate or polyisocyanates may vary. According to the first embodiment, the amount of isocyanate (including polyisocyanate(s)) and solvent present in the solvent-based isocyanate-containing activator may vary. In certain embodiments of the first embodiment, the solvent-based isocyanate-containing activator includes (comprises) greater than 50% by weight (e.g., 50%, 55%, 60%, 65%, 70%, 75%, 80%, 85%, 90%, or more by weight), preferably at least 60% by weight (e.g., 60%, 65%, 70%, 75%, 80%, 85%, 90%, or more by weight), more preferably at least 70% by weight (e.g., 60%, 65%, 70%, 75%, 80%, 85%, 90%, or more by weight) of solvent, based upon the total weight of the solvent-based isocyanate-containing activator. In certain embodiments of the first embodiment, the solvent-based isocyanate containing activator contains (comprises) 5-30% by weight (e.g., 5, 6, 7, 8, 9, 10, 11, 12, 13, 14, 15, 16, 17, 18, 19, 20, 21, 22, 23, 24, 25, 26, 27, 28, 29, or 30% by weight) isocyanate, preferably 5-10% by weight (e.g., 5, 6, 7, 8, 9, or 10% by weight) isocyanate, based upon the total weight of the solvent-based isocyanate-containing activator. In those embodiments of the first embodiment where the isocyanate (isocyanate component) comprises a polyisocyanate, the particular polyisocyanate or polyisocyanates may vary. In certain embodiments of the first embodiment wherein the isocyanate (isocyanate component) comprises a polyisocyanate, the polyisocyanate is a di-isocyanate compound, a tri-isocyanate compound, or a combination thereof. In preferred embodiments of the first embodiment wherein the isocyanate (isocyanate component) comprises a polyisocyanate, the polyisocyanate is a tri-isocyanate compound. In certain embodiments of the first embodiment wherein the isocyanate (isocyanate component) comprises a polyisocyanate, the polyisocyanate contains an aromatic group, preferably a phenyl group or benzyl group. In certain embodiments of the first embodiment wherein the isocyanate (isocyanate component) comprises a polyisocyanate, the polyisocyanate includes a phosphate group, preferably a thiophosphate group. In certain embodiments of the first embodiment wherein the isocyanate (isocyanate component) comprises a polyisocyanate, at least one of the following, preferably each of the following, more preferably each of the following in its preferable form, is met: (a) the polyisocyanate is a di-isocyanate compound, a tri-isocyanate compound, or a combination thereof, preferably a tri-isocyanate compound, (b) the polyisocyanate contains an aromatic group, preferably a phenyl group or benzyl group, or (c) the polyisocyanate includes a phosphate group, preferably a thiophosphate group. In certain embodiments of the first embodiment, the isocyanate comprises the tri-isocyanate tris(4-isocyanatophenyl)thiophosphate; in certain such embodiments the isocyanate consists of (only) tri-isocyanate tris(4-isocyanatophenyl)thiophosphate. The foregoing discussion relating to the isocyanate(s) and solvent(s) present in the solvent-based isocyanate-containing activator should be understood to apply equally to the second and third embodiments disclosed herein. The foregoing discussion relating to the isocyanate(s) present in the solvent-based isocyanate-containing activator should be understood to apply equally to the second-fifth embodiments disclosed herein (since according to the second-fifth embodiments, the isocyanate(s) will remain in the treatment coating even after the solvent(s) have been evaporated).

According to the first embodiment, the solvent or solvents present in the solvent-based isocyanate-containing activator may vary in type and amount. In certain embodiments of the first embodiment, the solvent-based isocyanate-containing activator comprises (includes) at least one polar solvent, preferably one or more ester polar solvents, more preferably at least one acetate ester polar solvent; in certain of the foregoing embodiments, the solvent content (solvent component amount) is as discussed in the following sentence. In certain embodiments of the first embodiment, the solvent-based isocyanate-containing activator has a solvent content (solvent component amount) of greater than 50% by weight (e.g., 50%, 55%, 60%, 65%, 70%, 75%, 80%, 85% by weight, or more), preferably at least 60% by weight (e.g., 60%, 65%, 70%, 75%, 80%, 85% by weight, or more), more preferably at least 70% by weight (e.g., 70%, 75%, 80%, 85% by weight, or more), based upon the total weight of the solvent-based isocyanate-containing activator. The foregoing discussion relating to the solvent(s) present in the solvent-based isocyanate-containing activator should be understood to apply equally to the second and third embodiments disclosed herein.

In certain embodiments of the first embodiment, the solvent-based isocyanate-containing activator contains ingredients in addition to the isocyanate and solvent, as discussed above. In certain embodiments of the first embodiment, the solvent-based isocyanate-containing activator includes (comprises) a coupling agent in an amount of up to 10% (e.g., 10%, 9%, 8%, 7%, 6%, 5%, 4%, 3%, 2%, 1%, 1-10%, etc.) by weight (based upon the total weight of the solvent-based isocyanate-containing activator), preferably a resorcinol-based coupling agent in an amount of up to 10% (e.g., 10%, 9%, 8%, 7%, 6%, 5%, 4%, 3%, 2%, 1%, 1-10%, etc.) by weight (based upon the total weight of the solvent-based isocyanate-containing activator). The foregoing discussion relating to other ingredients present in the solvent-based isocyanate-containing activator should be understood to apply equally to the second and third embodiments disclosed herein. The foregoing discussion relating to the other ingredients present in the solvent-based isocyanate-containing activator should be understood to apply equally to the second-fifth embodiments disclosed herein (since according to the second-fifth embodiments, those other ingredients will generally remain in the treatment coating even after the solvent(s) have been evaporated).

According to the first embodiment, the viscosity of the solvent-based isocyanate-containing activator may vary. In certain embodiments of the first embodiment, the solvent-based isocyanate-containing activator has a viscosity of 35-50 (e.g., 35, 36, 37, 38, 39, 40, 41, 42, 43, 44, 45, 46, 47, 48, 49, or 50), preferably 40-45 (e.g., 40, 41, 42, 43, 44, or 45), seconds, as measured using a DIN #2 cup at 25 °C. The foregoing viscosities refer to measurements made using a DIN #2 cup (2 mm cup) and the number of seconds represents the time for the activator to empty from the cup. Detailed guidance for making such viscosity measurements can be found in the ASTM D1084 standard. The foregoing discussion relating to the viscosity of the solvent-based isocyanate-containing activator should be understood to apply equally to the second and third embodiments disclosed herein.

In certain embodiments of the first embodiment, the solvent-based isocyanate-containing activator meets at least one of the following: (a) has a solvent content of greater than 50% by weight (e.g., 50%, 55%, 60%, 65%, 70%, 75%, 80%, 85% by weight, or more), preferably at least 60% by weight (e.g., 60%, 65%, 70%, 75%, 80%, 85% by weight, or more), more preferably at least 70% by weight (e.g., 70%, 75%, 80%, 85% by weight, or more), (b) contains (comprises) 5-30% by weight (e.g., 5, 6, 7, 8, 9, 10, 11, 12, 13, 14, 15, 16, 17, 18, 19, 20, 21, 22, 23, 24, 25, 26, 27, 28, 29, or 30% by weight), preferably 5-10% by weight (e.g., 5, 6, 7, 8, 9, or 10% by weight) of isocyanate, (c) contains (comprises) a coupling agent, preferably a resorcinol-based coupling agent, in an amount of up to 10% by weight, (d) contains (comprises) at least one polar solvent, preferably at least one ester polar solvents, more preferably at least one acetate ester polar solvent, or (e) has a viscosity of 35-50 (e.g., 35, 36, 37, 38, 39, 40, 41, 42, 43, 44, 45, 46, 47, 48, 49, or 50), preferably 40-45 (e.g., 40, 41, 42, 43, 44, or 45), seconds, as measured using a DIN #2 cup at 25 °C. In certain preferred embodiments of the first embodiment, at least one of (a)-(e) is met in their preferred forms, as applicable, more preferably in their more preferred forms, as applicable. In certain embodiments of the first embodiment, at least one of (a)-(e) is met, preferably each of (a)-(e), and the solvent-based isocyanate-containing activator also includes curatives (as discussed above). The foregoing discussion relating to the solvent(s) present in the solvent-based isocyanate-containing activator and viscosity of the activator should be understood to apply equally to the second and third embodiments disclosed herein. The foregoing discussion relating to the isocyanate and coupling agent present in the solvent-based isocyanate-containing activator should be understood to apply equally to the second-fifth embodiments disclosed herein (since with respect to the fourth and fifth embodiments, the isocyanate and/or any coupling agent will generally remain in the treatment coating even after the solvent(s) have been evaporated).

In certain embodiments of the first embodiment, after applying the solvent-based isocyanate-containing activator, the method includes allowing the solvent(s) in the solvent-based isocyanate-containing activator to evaporate prior to insert molding. In certain such embodiments, allowing the solvent(s) to evaporate includes heating, and the temperature at which the heating takes place may vary and the time for which the heating occurs may vary. In certain embodiments of the first embodiment, the heating is to a temperature of 20 to 140 °C (e.g., 20, 22, 24, 25, 26, 28, 30, 32, 34, 35, 36, 38, 40, 42, 44, 45, 46, 48, 50, 52, 54, 55, 56, 58, 60, 62, 64, 65, 66, 68, 70, 72, 74, 75, 76, 78, 80, 82, 84, 85, 86, 88, 90, 92, 94, 95, 96, 98, 100, 102, 104, 105, 106, 108, 110, 112, 114, 115, 116, 118, 120, 122, 124, 125, 126, 128, 130, 132, 134, 135, 136, 138, or 140 °C). In certain embodiments of the first embodiment, the elongated spoke is heated for 2 minutes to 0.5 hours (e.g., 2, 3, 4, 5, 6, 7, 8, 9, 10, 11, 12, 13, 14, 15, 16, 17, 18, 19, 20, 21, 22, 23, 24, 25, 26, 27, 28, or 29 minutes, or 0.5 hours), preferably 5-10 minutes (e.g., 5, 6, 7, 8, 9, or 10 minutes) to evaporate the solvent(s). In certain embodiments of the first embodiment, the heating is to a temperature of 20 to 140 °C (e.g., 20, 22, 24, 25, 26, 28, 30, 32, 34, 35, 36, 38, 40, 42, 44, 45, 46, 48, 50, 52, 54, 55, 56, 58, 60, 62, 64, 65, 66, 68, 70, 72, 74, 75, 76, 78, 80, 82, 84, 85, 86, 88, 90, 92, 94, 95, 96, 98, 100, 102, 104, 105, 106, 108, 110, 112, 114, 115, 116, 118, 120, 122, 124, 125, 126, 128, 130, 132, 134, 135, 136, 138, or 140 °C) for 2 minutes to 0.5 hours (e.g., 2, 3, 4, 5, 6, 7, 8, 9, 10, 11, 12, 13, 14, 15, 16, 17, 18, 19, 20, 21, 22, 23, 24, 25, 26, 27, 28, or 29 minutes, or 0.5 hours), preferably 5-10 minutes (e.g., 5, 6, 7, 8, 9, or 10 minutes).

### Insert Molding

The method of the first embodiment includes insert molding a polyurethane flexure onto at least a portion of the treated texture imprint surface (of the cured elongated composite spoke). As discussed in more detail below, the insert molding results in a polyurethane flexure-elongated composite spoke bonded combination with a peel strength as discussed below. It should be understood that the foregoing particulars of insert molding may also be used to produce the polyurethane flexure-elongated composite spoke bonded combination of the second and fourth embodiments, as well as the bonded combination used in the non-pneumatic tire of the third and fifth embodiments.

As used herein, insert molding refers to a method of injection molding that adds molten or liquid materials into a mold and then allows them to cool and solidify. As part of insert molding a component is present within the mold and when the molten or liquid materials are added to the mold, the materials flow over the component and mold around not only the mold walls but also around or onto the component piece, thereby forming a bond with the component piece. According to the first embodiment disclosed herein, the component present within the mold for the insert molding is at least a portion of the (first) end of the elongated composite spoke and the molten or liquid materials are polyurethane. More specifically, the elongated composite spoke is present within the mold to an extent necessary to allow for the polyurethane materials to form a bond with the treated texture imprint surface (upon at least the first surface of the end of the elongated composite spoke). In certain embodiments of the first embodiment, the polyurethane materials used are liquid or at least pourable at room temperature. In other embodiments of the first embodiment, the polyurethane materials are gel or solid at room temperature.

Generally, polyurethanes such as the polyurethane used to insert mold the flexure onto the treated texture imprint surface of the elongated composite spoke can be understood to be polymers comprised of organic units joined by carbamate (urethane) links. Polyurethane can be produced from a wide range of starting materials. The polyurethanes suitable for use in (insert molding) the flexure, as described herein, will include an isocyanate component and a diol component. It should be understood that the foregoing particulars of polyurethanes may also be applicable to producing the polyurethane flexure-elongated composite spoke bonded combination of the second and fourth embodiments, as well as the bonded combination used in the non-pneumatic tire of the third and fifth embodiments.

Generally, according to the first-fifth embodiments disclosed herein, one or more than one type of diol can be utilized (or present in) the diol component of the polyurethane of the flexure. The diol may be aromatic or aliphatic. In certain embodiments of the first-fifth embodiments, the diol component of the polyurethane of the flexure is aromatic. In other preferred embodiments of the first-fifth embodiments, the diol component of the polyurethane of the flexure is aliphatic. Generally, the diol used in the diol component of the polyurethane may vary and suitable diols include those having 2 to 20 carbon atoms (e.g., 2, 3, 4, 5, 6, 7, 8, 9, 10, 11, 12, 13, 14, 15, 16, 17, 18, 19 or 20 carbon atoms), preferably 2 to 10 carbon atoms, even more preferably 2 to 6 carbon atoms. According to the first-fifth embodiments, the diol component of the polyurethane of the flexure may be selected from the group consisting of simple diols, and complex polyols including polyester polyols, polyether polyols, polycarbonate polyols, polycaprolactone polyols, polybutadiene polyols, and polysulfide polyols. In certain embodiments of the first-fifth embodiments, the polyurethane of the flexure includes a diol component selected from the group consisting of simple diols, polyester polyols, polyether polyols, polycarbonate polyols, polycaprolactone polyols, polybutadiene polyols, polysulfide polyols, and combinations thereof. Non-limiting examples of aliphatic diols include ethylene glycol, 1,4-butanediol, and 1,6-hexanediol, each of which can be understood as simple diols. In certain embodiments of the first-fifth embodiments, the diol component of the polyurethane of the flexure is selected from the group consisting of ethylene glycol, 1,4-butanediol, 1,6-hexanediol, and combinations thereof. In certain embodiments of first-fifth embodiments, the diol component of the polyurethane of the flexure consists of ethylene glycol. In certain embodiments of first-fifth embodiments, the diol component of the polyurethane of the flexure consists of 1,4-butanediol. In certain embodiments of first-fifth embodiments, the diol component of the polyurethane of the flexure consists of 1,6-hexanediol. Non-limiting examples of aromatic diols include those based upon terephthalic acid including diesters of terephthalic acid with diols having 2-4 carbon atoms.

Generally, according to the first-fifth embodiments disclosed herein, one or more than one type of isocyanate can be utilized (or present in) the isocyanate component of the polyurethane of the flexure. The isocyanate may be aliphatic or aromatic. In certain embodiments of the first-fifth embodiments, the isocyanate component of the polyurethane of the flexure is aromatic or includes an aromatic isocyanate. In other embodiments of the first-fifth embodiments, the isocyanate component is aliphatic or includes an aliphatic isocyanate. In certain embodiments of the first-fifth embodiments, the isocyanate component of the polyurethane is an aromatic diisocyanate selected from the group consisting of 4,4′-diphenylmethane diisocyanate (also known as methylene diphenyl diisocyanate), toluene diisocyanate, paraphenyl diisocyanate, and combinations thereof.

Exemplary aliphatic isocyanates suitable for use as the isocyanate component of the polyurethane of the flexure include, but are not limited to, hexamethylene diisocyanate (HDI), ethylene diisocyanate, methylene dicyclohexyl diisocyanate (MDI), hydrogenated methylene dicyclohexyl diisocyanate (HMDI) or 4,4′-diisocyanato dicyclohexylmethane, isophorone diisocyanate (IPDI) or 1-isocyanato-3-isocyanatomethyl-3,5,5-trimethyl-cyclohexane, 1,6-diisocyanatohexane, tetramethylxylylene diisocyanate (TMXDI), alkylene diisocyanates with 4-12 carbon atoms in the alkylene radical (e.g., 1,2-dodecane diisocyanate, 1,4-tetramethylene diisocyanate), 1,4-cyclohexane diisocyanate, 1,3-cyclohexane diisocyanate, 4,4′-dicyclohexylmethane diisocyanate, 2,2′-dicyclohexylmethane diisocyanate, 2,4′-dicyclohexylmethane diisocyanate, and combinations thereof. In certain embodiments of the first-fifth embodiments, the isocyanate component of the polyurethane is an aliphatic diisocyanate containing an aliphatic ether group. In certain embodiments of the first-fifth embodiments, the isocyanate component of the polyurethane of the flexure is selected from the group consisting of hexamethylene diisocyanate (HDI), ethylene diisocyanate, methylene dicyclohexyl diisocyanate (MDI), hydrogenated methylene dicyclohexyl diisocyanate (HMDI) or 4,4′-diisocyanato dicyclohexylmethane, isophorone diisocyanate (IPDI) or 1-isocyanato-3-isocyanatomethyl-3,5,5-trimethyl-cyclohexane, 1,6-diisocyanatohexane, tetramethylxylylene diisocyanate (TMXDI), alkylene diisocyanates with 4-12 carbon atoms in the alkylene radical (e.g., 1,2-dodecane diisocyanate, 1,4-tetramethylene diisocyanate), 1,4-cyclohexane diisocyanate, 1,3-cyclohexane diisocyanate, 4,4′-dicyclohexylmethane diisocyanate, 2,2′-dicyclohexylmethane diisocyanate, 2,4′-dicyclohexylmethane diisocyanate, and combinations thereof.

In certain embodiments of the first-fifth embodiments disclosed herein, the polyurethane of the flexure includes (further comprises) at least one chain extender. In other embodiments of the first-fifth embodiments, the polyurethane of the flexure contains no chain extender. In those embodiments of the first-fifth embodiments wherein the polyurethane of the flexure includes (further comprises) at least one chain extender, the particular chain extender or extenders utilized may vary. In preferred embodiments of the first-fifth embodiments, the chain extender comprises a diol having 2 to 20 carbon atoms (e.g., 2, 3, 4, 5, 6, 7, 8, 9, 10, 11, 12, 13, 14, 15, 16, 17, 18, 19 or 20 carbon atoms), preferably 2 to 10 carbon atoms, even more preferably 2 to 6 carbon atoms. Generally, the chain extender may be either aliphatic or aromatic. In preferred embodiments of the first-fifth embodiments, any chain extender utilized is aliphatic. Non-limiting examples of aliphatic diols include ethylene glycol, 1,4-butanediol, and 1,6-hexanediol. In certain embodiments of the first-fifth embodiments, the chain extender of the polyurethane of the flexure comprises at least one aliphatic diol, preferably selected from the group consisting of ethylene glycol, 1,4-butanediol, 1,6-hexanediol, and combinations thereof; in certain such embodiments, the chain extender of the polyurethane of the flexure consists of at least one aliphatic diol, preferably selected from the preceding group. Non-limiting examples of aromatic diols include those based upon terephthalic acid including diesters of terephthalic acid with diols having 2-4 carbon atoms. In certain embodiments of the first-fifth embodiments, the chain extender of the polyurethane of the flexure comprises at least one aromatic diol; in certain such embodiments, the chain extender of the polyurethane of the flexure consists of at least one aromatic diol.

The particular properties of the polyurethane flexure of the first-fifth embodiments may vary. For example, in certain embodiments of the first-fifth embodiments, the polyurethane flexure is capable of functioning without cracking or tearing in temperatures ranging from −65 °F to 160 °F (−55 to 70 °C).

### Polyurethane Flexure-Elongated Composite Spoke Bonded Combination

According to the method of the first embodiment, the insert molding, as discussed above, results in a polyurethane flexure-elongated composite spoke bonded combination wherein the polyurethane flexure is bonded to the end of the cured elongated composite spoke at at least its first surface. According to the second-fifth embodiments, the polyurethane flexure-elongated composite spoke bonded combination also includes a polyurethane flexure bonded to the end of the elongated composite spoke at at least its first surface (or alternatively explained as its treated texture imprint surface). In certain embodiments of the first-fifth embodiments, the polyurethane flexure is bonded to the end of the elongated composite spoke at its first surface (at its treated texture imprint surface upon the first surface). In other embodiments of the first-fifth embodiments, the polyurethane flexure is bonded to the end of the elongated composite spoke at its first surface and its second surface (at its treated texture imprint surface upon the first and second surfaces) ; in certain such embodiments the polyurethane flexure is bonded to the entire outer surface of the (first) end of the elongated spoke, i.e., both the first surface and the second surface as well as any other surfaces between those two surfaces, or at the treated texture imprint surface upon the entire outer surface of the first end of the elongated composite spoke.

According to the method of the first embodiment, and in the second-fifth embodiments, the polyurethane flexure is bonded to the end of the elongated composite spoke (i.e., at at least its first surface or at its treated texture imprint surface, as discussed above) with a peel strength of at least 120 pli (e.g., 120, 130, 140, 150, 160, 170, 180, 190, 200, 210, 220, 230, 240, 250, etc.), 120-250 pli, at least 21000 N/m (e.g., 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000 N/m, etc.) or 21000-44000 N/m. Alternatively stated, the polyurethane flexure-elongated composite spoke bonded combination has a peel strength as stated. As used herein, pli refers to pounds per linear inch and N/m refers to Newtons per meter. In preferred embodiments of the first-fifth embodiments, the peel strength is at least 140 pli (e.g., 140, 150, 160, 170, 180, 190, 200, 210, 220, 230, 240, 250, etc.), 140-250 pli, at least 24000 N/m (e.g., 24000, 25000, 26000, 27000, 28000, 29000, 30000, 31000, 32000, 33000, 34000, 35000, 36000, 37000, 38000, 39000, 40000, 41000, 42000, 43000, 44000 N/m, etc.), or 24000-44000 N/m. In more preferred embodiments of the first-fifth embodiments, the peel strength is at least 150 pli (e.g., 150, 160, 170, 180, 190, 200, 210, 220, 230, 240, 250 pli, etc.), 150-250 pli, at least 26000 N/m (e.g., 26000, 27000, 28000, 29000, 30000, 31000, 32000, 33000, 34000, 35000, 36000, 37000, 38000, 39000, 40000, 41000, 42000, 43000, 44000 N/m, etc.), or 26000-44000 N/m. The foregoing peel strengths can be measured in accordance with ASTM D6892/D903 and at room temperature (i.e., 25 °C).

The shape of the polyurethane flexure that results from insert molding and/or that is bonded to the end of the elongated composite spoke, as discussed above, may vary. In certain embodiments of the first-fifth embodiments, the polyurethane flexure has a shape selected from the group consisting of a rectangular cuboid; a curved hourglass; a polygon with an inner surface, an outer surface, and a perimeter edge between the inner and outer surfaces, wherein at least a portion of the perimeter edge curves inward; and combinations thereof. As used herein, the phrase curves inward is meant to refer to a portion of the perimeter edge having a concave profile that can be selected from various shapes including elliptical, partial circular, or irregular. In certain embodiments of the first-fifth embodiments, the polyurethane flexure has a rectangular cuboid shape. In certain embodiments of the first-fifth embodiments, the polyurethane flexure has a curved hourglass shape. In certain embodiments of the first-fifth embodiments, the polyurethane flexure has a polygon shape with an inner surface, an outer surface, and a perimeter edge between the inner and outer surfaces, wherein at least a portion of the perimeter edge curves inward. As well, the polyurethane flexure that results from insert molding can be understood as having two facing surfaces, more specifically a spoke facing surface(where the polyurethane flexure is bonded to the spoke, as discussed above) and a band facing surface (where the polyurethane flexure will contact and be bonded to an inner surface of the outer ring (also referred to herein as the annular ring) of the non-pneumatic tire). The attachment between the polyurethane flexure and the outer ring may be achieved using welding, brazing, soldering, adhesives, mechanical fasteners (e.g., bolts, rivets), key/keyway connections, or any other desired arrangement. In those embodiments of first-fifth embodiments where adhesive is used to bond the polyurethane flexure to the outer ring, the particular adhesive used may vary. In certain embodiments of the first-fifth embodiments, an epoxy adhesive is used to bond the polyurethane flexure to the outer ring. In other embodiments of the first-fifth embodiments, a hot melt adhesive is used to bond the polyurethane flexure to the outer ring.

### Fourth and Fifth Embodiments

As mentioned above, the fourth embodiment disclosed herein is directed to a polyurethane flexure-elongated composite spoke bonded combination for use in a non-pneumatic tire, the combination comprising: a cured elongated composite spoke having an end with a first surface and a second surface, wherein the cured elongated composite spoke is comprised of fibers selected from the group consisting of carbon fibers, glass fibers, aramid fibers, and combinations thereof and an epoxy resin, and a polyurethane flexure bonded to the end of the elongated composite spoke with a peel strength of at least 120 pli (at least 21000 N/m), preferably at least 140 pli (at least 24000 N/m), more preferably at least 150 pli at 26000 N/m, as determined using a 90 degree peel strength test (in accordance with ASTM D6892/D903), wherein the end of the elongated composite spoke has a treated texture imprint surface upon at least its first surface underneath the bonded polyurethane flexure, wherein the treated texture imprint surface includes a treatment coating over a texture imprint surface. The texture coating can be understood as being over (or on top of) the texture imprint surface. As also mentioned above, the fifth embodiment disclosed herein is directed to a non-pneumatic tire incorporating the polyurethane flexure-elongated composite spoke bonded combination of the fourth embodiment. The paragraphs which follow and are specifically directed to the fourth and fifth embodiments disclosed herein should not be understood as limiting the fourth and fifth embodiments to only those options discussed immediately below. Instead, the fourth and fifth embodiments should be understood to be disclosed as broadly as stated above with respect to the fourth and fifth embodiments as well as would be understood to result from the method of the first-third embodiments as discussed above.

In certain embodiments of the fourth and fifth embodiments, wherein the treated texture imprint surface has a roughness average Ra of 150 to 450 microinches (e.g., 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, or 450 microinches) or 4 to 11 micrometers (e.g., 4, 5, 6, 7, 8, 9, 10, or 11 micrometers), preferably 200 to 400 microinches (e.g., 200, 210, 220, 230, 240, 250, 260, 270, 280, 290, 300, 310, 320, 330, 340, 350, 360, 370, 380, 390, or 400 microinches) or 5 to 10 micrometers (e.g., 5, 6, 7, 8, 9, or 10 micrometers), as determined by profilometry, as discussed above.

In certain embodiments of the fourth and fifth embodiments, the texture imprint surface has an average maximum height of the profile or average maximum profile height Rz of 1200 to 1700 microinches (e.g., 1200, 1300, 1400, 1500, 1600, or 1700 microinches) or 30 to 43 micrometers (e.g., 30, 31, 32, 33, 34, 35, 36, 37, 38, 39, 40, 41, 42, or 43 micrometers), preferably 1300 to 1600 microinches (e.g., 1300, 1400, 1500, 1600, or 1700 microinches) or 33 to 41 micrometers (e.g., 33, 34, 35, 36, 37, 38, 39, 40, or 41 micrometers), as determined by profilometry, as discussed above. In certain embodiments of the fourth and fifth embodiments, the texture imprint has a surface roughness average Ra and an average maximum height of the profile Rz according to the foregoing respective ranges, preferably according to the foregoing respective preferred ranges.

In certain embodiments of the fourth and fifth embodiments, the treatment coating has a thickness of 0.5 to 10 nm.

In certain embodiments of the fourth and fifth embodiments, the epoxy resin of the elongated composite spoke has a cure time of no more than 15 minutes at 150 °C, preferably no more than 12 minutes at 150 °C.

In certain embodiments of the fourth and fifth embodiments, the first surface of the elongated composite spoke is flattened.

In certain embodiments of the fourth and fifth embodiments, the polyurethane flexure has a shape selected from the group consisting of a rectangular cuboid; a curved hourglass; a polygon with an inner surface, an outer surface, and a perimeter edge between the inner and outer surfaces, wherein at least a portion of the perimeter edge curves inward; and combinations thereof.

### Non-Pneumatic Tire Including the Polyurethane Flexure-Elongated Composite Spoke Bonded Combination

As mentioned above, the third embodiment disclosed herein is directed to a non-pneumatic tire incorporating the polyurethane flexure-elongated composite spoke bonded combination of the second embodiment, which combination is made by the method of the first embodiment. As also mentioned above, the fifth embodiment disclosed herein is directed to a non-pneumatic tire incorporating the polyurethane flexure-elongated composite spoke bonded combination of the fourth embodiment. Also disclosed herein is an embodiment of the method of the first embodiment, wherein the method further comprises adding the polyurethane flexure-elongated composite spoke bonded combination to a non-pneumatic tire, preferably by bonding the polyurethane flexure-elongated composite spoke bonded combination to an outer ring within the non-pneumatic tire, wherein the outer ring has an outer surface and an inner surface and is covered on its outer surface by a tread and bonded on its inner surface via the polyurethane flexure to the polyurethane flexure-elongated composite spoke bonded combination. The non-pneumatic tire of the fifth embodiment disclosed herein can be understood as including the polyurethane flexure-elongated composite spoke bonded combination of the fourth embodiment, wherein the polyurethane flexure-elongated composite spoke bonded combination is bonded to an outer ring within the non-pneumatic tire, wherein the outer ring has an outer surface and an inner surface and is covered on its outer surface by a tread and bonded on its inner surface via the polyurethane flexure to the polyurethane flexure-elongated composite spoke bonded combination.

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1-24. (canceled)

25. A method for producing a polyurethane flexure-elongated composite spoke bonded combination for use in a non-pneumatic tire, the method comprising
providing an uncured elongated composite spoke having an end with a first surface and a second surface, wherein the uncured elongated composite spoke is comprised of fibers selected from the group consisting of carbon fibers, glass fibers, aramid fibers, and combinations thereof and an epoxy resin;
applying a peel ply fabric to at least the first surface of the uncured elongated composite spoke to produce a peel ply fabric-uncured elongated composite spoke combination, wherein the peel ply fabric comprises woven synthetic fabric having warp threads and weft threads;
curing the peel ply fabric-uncured elongated composite spoke combination by the application of heat and pressure to produce a cured peel ply fabric-cured elongated composite spoke combination;
removing the cured peel ply fabric from the cured peel ply fabric-cured elongated composite spoke combination to produce a cured elongated composite spoke having a texture imprint surface;
applying a solvent-based isocyanate-containing activator over the texture imprint surface to produce a treated texture imprint surface; and
insert molding a polyurethane flexure onto at least a portion of the treated texture imprint surface,
thereby producing a polyurethane flexure-elongated composite spoke bonded combination having a peel strength of at least 120 pli (at least 21000 N/m), as determined using a 90 degree peel strength test (in accordance with ASTM D6892/D903).

26. The method of claim 25, wherein the solvent-based isocyanate-containing activator comprises a polyisocyanate.

27. The method of claim 25, wherein the polyisocyanate meets at least one of the following: (a) is a di-isocyanate or a tri-isocyanate compound, (b) contains an aromatic group, or (c) includes a phosphate group.

28. The method of claim 25, further comprising allowing the solvents in the solvent-based isocyanate-containing activator to evaporate prior to insert molding.

29. The method of claim 25, wherein the solvent-based isocyanate-containing activator meets at least one of the following:
a. has a solvent content of greater than 50% by weight,
b. contains 5-30% by weight of isocyanate,
c. contains a coupling agent in an amount of up to 10% by weight,
d. contains at least one ester polar solvent, or
e. has a viscosity of 35-50 seconds, as measured using a DIN #2 cup at 25 °C.

30. The method of claim 25, wherein the treated texture imprint surface meets at least one of the following: (a) has a roughness average Ra of 150 to 450 microinches (4 to 11 micrometers), as determined by profilometry, or (b) has an average maximum height of the profile Rz of 1200 to 1700 microinches (30 to 43 micrometers).

31. The method of claim 25, wherein the peel ply fabric is free of resin.

32. The method of claim 25, wherein the peel ply fabric includes an epoxy resin having a cure time of no more than 15 minutes at 150 °C.

33. The method of claim 25, wherein the peel ply fabric is free of release agents.

34. The method of claim 25, wherein the peel ply fabric contains at least one release agent.

35. The method of claim 25, wherein the woven synthetic fabric of the peel ply fabric has 10 to 100 warp threads/cm, and 10 to 60 weft threads/cm.

36. The method of claim 25, wherein the epoxy resin of the uncured elongated spoke has a cure time of no more than 12 minutes at 150 °C.

37. The method of claim 25, wherein the first surface of the uncured elongated composite spoke is flattened.

38. The method of claim 25, wherein the polyurethane flexure has a shape selected from the group consisting of a rectangular cuboid; a curved hourglass; a polygon with an inner surface, an outer surface, and a perimeter edge between the inner and outer surfaces, wherein at least a portion of the perimeter edge curves inward; and combinations thereof.

39. The method of claim 25, further comprising adding the polyurethane flexure-elongated composite spoke bonded combination to a non-pneumatic tire by bonding the polyurethane flexure-elongated composite spoke bonded combination to an outer ring within the non-pneumatic tire, wherein the outer ring has an outer surface and an inner surface and is covered on its outer surface by a tread and bonded on its inner surface via the polyurethane flexure to the polyurethane flexure-elongated composite spoke bonded combination.

40. A polyurethane flexure-elongated composite spoke bonded combination for use in a non-pneumatic tire, the combination comprising:
a cured elongated composite spoke having an end with a first surface and a second surface, wherein the elongated composite spoke is comprised of fibers selected from the group consisting of carbon fibers, glass fibers, aramid fibers, and combinations thereof and an epoxy resin; and
a polyurethane flexure bonded to the end of the cured elongated composite spoke with a peel strength of at least 120 pli (at least 21000 N/m), as determined using a 90 degree peel strength test (in accordance with ASTM D6892/D903),
wherein the end of the cured elongated composite spoke has a treated texture imprint surface upon at least its first surface underneath the bonded polyurethane flexure, wherein the treated texture imprint surface includes a treatment coating over a texture imprint surface.

41. The polyurethane flexure-elongated composite spoke bonded combination of claim 40, wherein the treated texture imprint surface meets at least one of the following: (a) has a roughness average Ra of 150 to 450 microinches (4 to 11 micrometers) as determined by profilometry., or (b) has an average maximum height of the profile Rz of 1200 to 1700 microinches (30 to 43 micrometers), as determined by profiliometry.

42. The polyurethane flexure-elongated composite spoke bonded combination of claim 40, wherein the first surface of the elongated composite spoke is flattened.

43. The polyurethane flexure-elongated composite spoke bonded combination of claim 40, wherein the polyurethane flexure has a shape selected from the group consisting of a rectangular cuboid; a curved hourglass; a polygon with an inner surface, an outer surface, and a perimeter edge between the inner and outer surfaces, wherein at least a portion of the perimeter edge curves inward; and combinations thereof.

44. A non-pneumatic tire incorporating the polyurethane flexure-elongated composite spoke bonded combination of claim 40.
